(19) United States
(12) Patent Application Publication
(10) Pub. No.: US 2011/0283555 A1
(43) Pub. Date: Nov. 24, 2011

(54) INDIRECTLY HEATED FLUIDIZED BED DRYER

(75) Inventors: Hans-Joachim Klutz, Erftstadt (DE); Claus Moser, Koln (DE)

(73) Assignee: RWE POWER AKTIENGESELLSCHAFT, Essen (DE)

(21) Appl. No.: 13/130,970

(22) PCT Filed: Nov. 24, 2008
(86) PCT No.: PCT/EP2008/009922

§ 371 Date: Aug. 10, 2011

(51) Int. Cl. F26B 3/084

(52) U.S. Cl. 34/90

(57) ABSTRACT

The invention relates to an indirectly heated fluidized bed dryer (1) for drying moist, fine-grained bulk materials. The fluidized bed dryer (1) comprises a housing (2) with a gas-injection bottom (6) with built-in heat exchanger parts extending above the gas-injection bottom (6) and at least one discharge device, provided below the gas-injection bottom (60), for the dried bulk material. The fluidized bed dryer (1) according to the invention is distinguished in that the usable flow cross section of the housing (2) increases in the region of the built-in heat exchanger parts while the cross-sectional area of the housing remains the same over the height of the built-in heat exchanger parts in the direction of flow of the fluidizing medium. In this way, an inadmissible expansion of the stationary fluidized bed is reliably prevented.

The invention relates to an indirectly heated fluidized bed dryer for drying moist, fine-grained bulk materials, such as for example brown coal, comprising a housing with a gas-injection bottom, with built-in heat exchanger parts extending above the gas-injection bottom and at least one discharge device, provided below the gas-injection bottom, for the dried bulk material, whereby the usable flow cross of the housing increases in the region of the built-in heat exchanger parts over the entire height of the built-in heat exchanger parts in the direction of flow of the fluidization gas.

A fluidized bed contact dryer of this type is known for example from EP 0 341 347 A1.

In the processing of brown coal as boiler coal to be burned in a steam generator, it is known simultaneously to size-reduce and to grind (grind-drying) the coal in beater wheel mills and hammer mills which are part of the power station boiler, the drying energy required for the drying being applied by a diverted flue gas flow.

As has already been described in the prior art, the drying of pit-moist crude brown coal in a fluidized bed dryer can be more beneficial from the point of view of energy. Nevertheless, fluidized bed contact dryers are complexly designed pieces of equipment. Efforts have therefore been made to configure the fluidized bed method in such a way as to allow the investment costs for the dryer to be kept as low as possible. For example, DE 196 20 047 A1 proposes for this purpose configuring the method in such a way as to allow operation to be carried out in the fluidized bed dryer at comparatively high flow speeds, so that the dryer can have a comparatively small cross-sectional area and thus base area.

Nevertheless, an excessively high flow speed of the gas flowing through the dryer is not desirable for the transfer of heat in the fluidized bed. From a critical speed, the stationary fluidized bed enters an unstable range because the discharge of very fine-grained material from the fluidized bed rises. This results in a coarsening of the bed material of the fluidized bed, having an adverse effect on the flow mechanics and the transfer of heat in the fluidized bed.

The evaporation of water within the dryer causes the mass flow of vapors to increase in the direction of flow, causing a corresponding rise in the flow speed of the gas or the vapors within the dryer.

CH 575 075 discloses a fluidized bed contact dryer, whereby the heat-exchanging walls each extend over at least 70% of the height of the fluidized bed. A decreased cross section in the uppest region of the heat-exchanging walls counteracts an increased flow speed. A settling zone is created in this region.

According to the theory of the transfer of heat in fluidized beds, the maximum of the transfer of heat is associated with a specific state of expansion of the fluidized bed or a specific speed in the fluidized bed. As a result, an excessive expansion of the fluidized bed impairs the mode of operation of the heat exchanger. In addition, a coarsening of the bed material as a result of the discharge of fine grains also impairs the mode of operation of the dryer.

EP 0 341 347 A1 describes a fluidized bed contact dryer, the housing of which is formed by at least one trough containing a respective heat exchanger which is flowed through by condensed steam and is in the form of a bundle of straight tubes in a plurality of steam channels with a significantly decreasing number of tubes or steam cross section. The tubes are arranged in the troughs of the contact dryer in such a way that a uniform division of the heating register is obtained.

A substantially constant flow speed of the heating steam within the tube bundle heat exchanger is achieved as a result of the measure according to EP 0 341 347. Nevertheless, the solution according to EP 0 341 347 A1 has the drawback that the cross-sectional area of the dryer housing is not constant over the height of the housing in the region of the built-in heat exchanger parts. This leads to flow-mechanical disturbances in the fluidized bed; this is not desirable simply for reasons of power optimization.

The invention is therefore based on the object of improving a fluidized bed dryer of the type mentioned at the outset with regard to a transfer of heat which is as optimal as possible.

The object is achieved by an indirectly heated fluidized bed dryer for drying moist, fine-grained bulk materials, comprising a housing with a gas-injection bottom with built-in heat exchanger parts extending above the gas-injection bottom and with at least one discharge device, provided below the gas-injection bottom, for the dried bulk material, whereby the usable flow cross of the housing increases in the region of the built-in heat exchanger parts over the entire height of the built-in heat exchanger parts in the direction of flow of the fluidization gas. The fluidized bed dryer according to the invention is characterized in that the cross section of the housing (2) remains constant and the packing density of the built-in heat exchanger parts decreases in the direction of flow of the fluidization gas.

Preferably, the housing of the fluidized bed dryer according to the invention possesses a rectangular, preferably a square cross section.

It is of course also possible for the housing to have a circular cross section.

Thus, an excessive increase in the flow speed of the gas or the vapor over the height of the housing is avoided in an advantageous manner. This reduces the dust discharge of the fine-grained content of the fluidized bed, thus improving the transfer of heat to the contact surfaces of the built-in heat exchanger parts.

Due to the decreasing packing density, it is possible without additional built-in parts to increase, while the cross section of the housing remains constant over the height of the heat exchangers, the size of the usable flow cross section of the housing with the consequence of a reduction of the increase in speed as the mass flow of vapors increases.

In a preferred variant of the fluidized bed dryer according to the invention, provision is made for the heat exchangers provided to be in the form of bundles of tubes and/or packs of plates which are combined to form segments of differing tube division and/or differing plate spacings.

For example, the heat exchangers provided can be in the form of bundles of tubes, segments of which are arranged with differing tube diameters and/or differing spacings from one another. Expediently, the tube diameters decrease in the direction of flow of the fluidization gas or the spacings thereof become larger in the direction of flow.

At least two or preferably three heat exchanger segments, for example in the form of heating registers, can be arranged in series or be connected in series in the direction of flow of the fluidization gas.

In a preferred variant of the fluidized bed dryer according to the invention, provision is made for all the heat exchanger segments to have approximately the same heat exchanging area, so that an on average falling speed level is set in the heat exchanger tubes.

The built-in heat exchanger parts can be embodied so as to have multiple channels; preferably, the built-in heat exchanger parts are embodied so as to have three channels, each channel being connected to a condensate collector. The latter measure prevents pressure losses owing to entrained condensate. The transfer of heat on the inside of the steam-heated tubes is increased as a result of the multiple-channel arrangement of the heat exchanger tubes; this helps to improve the heat transfer coefficient and thus the efficiency of the overall transfer of heat.

The size of the free areas, which determine the flow behavior, between the tubes is increased in particular by extending the tube division in the direction of flow or by reducing the tube diameters in the direction of flow. As a result, the rise in speed is reduced as a result of the upwardly increasing mass flow of steam. This reduces the dust discharge and a coarsening of the fluidized bed is effectively prevented. The transfer of heat is improved as a result of approximation of the intermediate tube speed to the optimum level which is theoretical for the transfer of heat. In addition, the specific evaporation power in kg/m² is increased until the critical speed is reached.

A variant of the fluidized bed dryer according to the invention is distinguished in that a funnel-shaped outlet is provided, which is geometrically configured in such a way that mass flow is set on withdrawal of bulk material. That means that the entire content of the outlet moves on withdrawal of material. There are no, or at most minimal, dead zones or quiescent bulk material zones. The opposite of this is generally referred to as what is known as a core flow which can under certain circumstances disturb the fluidization of the fluidized bed. This can occur, for example, when deposits, which are not moved on withdrawal of material, accumulate on the fixed bed below the gas-injection bottom.

Preferably, the steepness of the enclosing walls of the outlet is selected in such a way that mass flow is set on withdrawal of bulk material, i.e. the entire fixed bed moves at each point on withdrawal of material.

The invention will be described hereinafter based on an exemplary embodiment illustrated in the drawings, in which:

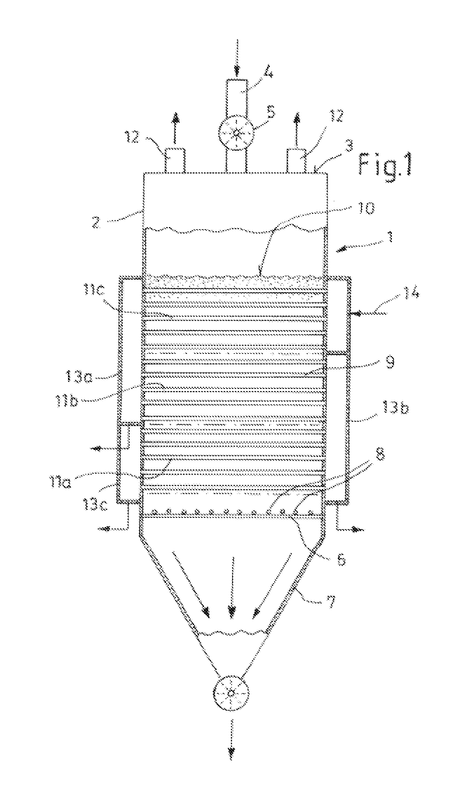

FIG. 1 is a schematic view of a fluidized bed dryer according to the invention, and

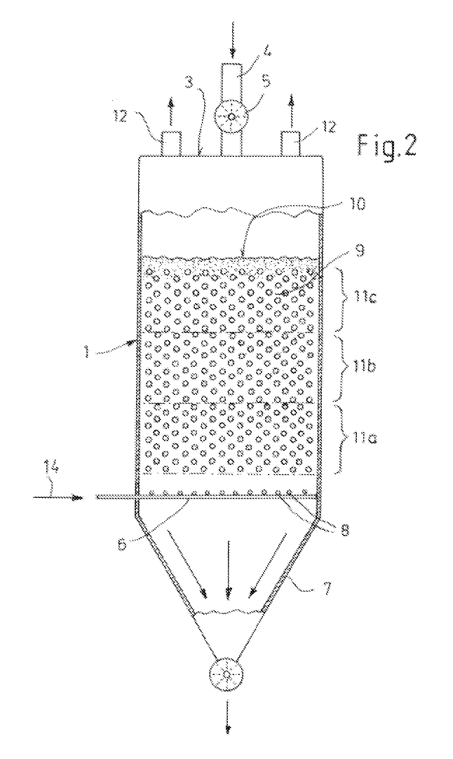

FIG. 2 is a section through the fluidized bed container from FIG. 1 offset through 90°.

The fluidized bed dryer (1) shown in FIG. 1 has a housing (2) with a rectangular cross section. A filling tube (4) with a cellular wheel sluice (5) is provided as a crude brown coal inlet at the upper end face (3) of the fluidized bed dryer (1). At the lower end of the fluidized bed dryer (1) that is remote from the upper end face (3), a funnel-shaped outlet (7), provided at the lower end of which a mechanical discharge, for example in the form of a cellular wheel sluice (5), is provided below a gas-injection bottom (6). Instead of this, a screw conveyor or the like could also be provided there as a mechanical discharge. The fluidized bed dryer (1) according to the exemplary embodiment is intended predominantly for drying brown coal and will be described with reference to a method for drying brown coal; however, the invention should be understood to mean that the dryer can also be used for drying other granular substances.

The gas-injection bottom (6) is provided on its side turned away from the material discharge (7) with nozzles (8) for introducing a fluidization gas. The fluidization gas or fluidizing medium may be in the form of water vapor. For the fluidization of the brown coal in the fluidized bed dryer (1), a partial flow can for example be diverted from the vapor leaving the fluidized bed dryer downstream of an electrostatic filter.

Above the gas-injection bottom (6), built-in heat exchanger parts in the form of bundles of tubes (9) or in the form of plates, through which steam flows as a heating medium, extend transversely to the gas flow and if appropriate at a slight inclination.

The brown coals, which are introduced into the fluidized bed dryer (1) for example at a grain size of 0 to 2 mm and a water content of up to 65% by weight, are held above the gas-injection bottom (6) in a quasi-stationary fluidized bed by means of the fluidizing medium, the level of the fluidized bed in the fluidized bed dryer (1) being marked by reference numeral (10). The brown coal grains in the fluidized bed enter in this case into contact with the tube bundle heat exchangers (9) which penetrate the housing transversely and are arranged in series in three segments 11a, 11b and 11c in the direction of flow. At temperatures of approximately 105 to 120° C., more than 50% of the original weight of the coal to be dried is evaporated as water. The mass flow of vapors in the region of the tube bundle heat exchangers (9) integrated in the fluidized bed increases upwards continuously as a result of the evaporation of the coal water. The speed of the vapors also rises accordingly.

From a critical speed, the stationary fluidized bed enters an unstable range and the dust discharge of the fine coal content of the fluidized bed rises markedly. Substantially the particle sizes of less than 300 μm are affected by this. As a result, a coarsening of the bed material of the fluidized bed is set, having an adverse effect on the flow mechanics and the transmission of heat in the fluidized bed.

For this reason, the built-in heat exchanger parts in the form of the tube bundle heat exchangers are designed in the described exemplary embodiments with division increasing in the direction of flow, resulting in an increase in the size of the useful cross section of the housing (2) while the cross section or diameter of the housing remains the same over the entire height of the built-in heat exchanger parts.

The greater spacing of the tubes of the tube bundle heat exchangers (9) relative to one another can be achieved either in that fewer tubes are arranged with greater spacing in a segment or in that the tubes are designed with a reduced diameter in the direction of flow.

In the present exemplary embodiment, provision is made for the spacing of the tubes relative to one another in the segment closest to the gas-injection bottom (6) to be less than in the subsequent segment 11b. The spacing of the of the tubes of the tube bundle heat exchanger (9) is greatest in the upper segment 11c, so that the cross section of the housing (2) that is useful in terms of flow is greatest there; this counteracts an increase in the speed of the mass flow of vapors in the direction of flow.

The vapor is removed from the fluidized bed dryer (1) via the vapor discharge channels (12).

The built-in heat exchanger parts in the housing (12) are designed as three-channeled tube bundle heat exchangers having a total of three condensate collectors (13a, b, c). The hot steam as a heating medium is introduced in the first, upper segment 11a into the tube bundle heat exchanger (9), which completely penetrates the housing (2), via the steam entry denoted by (14). The tubes, which run transversely and if appropriate at a slight inclination to the direction of flow of the fluidizing medium, are flowed through by the heating medium which flows into the condensate collector (13a) on the opposite side of the steam entry (14). The condensate which accumulates there is drawn off separately. Via the condensate collector (13a), the heating medium flows back into the condensate collector (13b) provided on the side of the steam entry (14) and, from there, into the bottom condensate collector 13c. The segments 11a, b, c or the heating registers 11a, b, c are configured in such a way that their heat exchanging area is approximately the same, so that an on average falling speed level is set in the individual channels.

The dried brown coal collects in the funnel-shaped outlet (7). The term “funnel-shaped” in the sense of the invention does not necessarily mean that the cross section of the outlet is embodied in a circular manner. The inclination of the enclosing walls of the outlet (7) is selected in such a way that mass flow is set on withdrawal of material, for example with the cellular wheel sluice. The term “mass flow” means, in contrast to “core flow”, that the entire content of the funnel is moving, so that the fixed bed subsides uniformly below the gas-injection bottom (6) on withdrawal of material. There are no, or at most minimal, dead zones, i.e. quiescent bulk material zones. The bulk material surface or the fixed bed subsides almost uniformly.

### List of Reference Numerals:

1. Fluidized bed dryer

2. Housing

3. End face

4. Filling tube

5. Cellular wheel sluice

6. Gas-injection bottom

7. Outlet

8. Nozzles

9. Tube bundle heat exchanger

10. Level of fluidized bed

11a, b, c Segments

12. Vapor discharge channel

13a, b, c Condensate collector

14 Steam entry

1-10. (canceled)

11. An indirectly heated fluidized bed dryer for drying moist, fine-grained bulk materials comprising a housing with a gas-injection bottom, with built-in heat exchanger parts extending above the gas-injection bottom and with at least one discharge device, provided below the gas-injection bottom, for the dried bulk material, whereby the usable flow cross of the housing increases in the region of the built-in heat exchanger parts over the entire height of the built-in heat exchanger parts in the direction of flow of the fluidization gas, characterized in that the cross section of the housing remains constant and the packing density of the built-in heat exchanger parts decreases in the direction of flow of the fluidization gas.

12. The fluidized bed dryer as claimed in claim 11, characterized in that the housing has a rectangular, preferably square cross section.

13. The fluidized bed dryer as claimed in claim 11, characterized in that the heat exchangers provided are in the form of bundles of tubes and/or packs of plates which are combined to form segments of differing tube division and/or differing plate spacings.

14. The fluidized bed dryer as claimed in claims 11, characterized in that the heat exchangers provided are in the form of tube bundle heat exchangers, segments of which are arranged with differing tube diameters and/or differing spacings from one another.

15. The fluidized bed dryer as claimed in claims 11, characterized in that at least two, preferably three heat exchanger segments are arranged in series in the direction of flow of the fluidization gas.

16. The fluidized bed dryer as claimed in claim 15, characterized in that all the heat exchanger segments have approximately the same heat exchanging area.

17. The fluidized bed dryer as claimed in claim 11, characterized in that the built-in heat exchanger parts are embodied so as to have multiple channels, preferably three channels, each segment being connected to a condensate collector.

18. The fluidized bed dryer as claimed in claim 11, characterized in that a funnel-shaped outlet is provided, which is geometrically configured in such a way that mass flow is set on withdrawal of bulk material.

19. The fluidized bed dryer as claimed in claim 18, characterized in that the steepness of the enclosing walls of the outlet is selected in such a way that mass flow is set on withdrawal of bulk material.
